(19) United States
(12) Patent Application Publication
(10) Pub. No.: US 2008/0269978 A1
(43) Pub. Date: Oct. 30, 2008

(54) Method and apparatus for vehicle performance tracking

(75) Inventors: Sanjay S. Shirole, Palo Alto, CA (US); Ananth Rani, Fremont, CA (US); Pramod Jajoo, Bangalore (IN)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: Xora, Inc., Mountain View, CA (US)

(21) Appl. No.: 11/789,473

(22) Filed: Apr. 25, 2007

(51) Int. Cl. G01M 17/00; G01C 21/00; G06F 3/06; H04B 1/38

(52) U.S. Cl. 701/30; 455/90.2; 701/213; 711/4

(57) ABSTRACT

Method and apparatus for vehicle performance tracking is described. In one example, a wireless interface is configured to receive operation data generated by a plurality of sensors in a vehicle. A time stamping module is configured to track time-of-day. A location module is configured to locate the vehicle. An engine tracking client is configured to produce instance performance data that relates the operation data, time-of-day information from the time stamping module, and location information from the location module. A cellular transceiver is configured to transmit the instance performance data to a server via a wireless mobile network.

### BACKGROUND OF THE INVENTION

1. Field of the Invention

Embodiments of the invention are generally related to keeping track of performance of fleets operating at geographically different locations and, more particularly, are related to using a wireless mobile network to track the performance and location of the fleets operating at geographically different locations.

2. Description of the Related Art

In order to be profitable, fleet operators often have a need to locate and dispatch vehicles and to check vehicle operating conditions on regular basis in order to be profitable. Vehicle location is necessary to track job performance. Regular check-ups are necessary to minimize the time spent for vehicle maintenance and repair. Regular check-ups often involve removing vehicles from the road to conduct fault analysis, scheduled maintenance, diagnostics monitoring and parameter modifications. These operations can only be accomplished by using skilled mechanics while the vehicle is physically parked and stopped in the maintenance bay. Thus, an increase in regular check-up time decreases the fleet operator's profitability.

In order to reduce the time spent in regular check-ups, fleet operators should be able monitor vehicle operating parameters in real time, while the vehicles are on road at various geographical locations. Existing solutions require installing an expensive dedicated on-board device in the vehicle. Further, these devices often do not provide a standard communication facility to communicate with the fleet operator.

Therefore, there is need for a system and method to allow fleet operators to monitor location and performance of vehicles operating at various geographical locations, in the real time.

### SUMMARY OF THE INVENTION

An aspect of the invention relates to vehicle location and performance tracking. A wireless interface is configured to receive operation data generated by a plurality of sensors in a vehicle. A time stamping module is configured to track time-of-day. A location module is configured to locate the vehicle. An engine tracking client is configured to produce instance performance data that relates the operation data, time-of-day information from the time stamping module, and location information from the location module. A cellular transceiver is configured to transmit the instance performance data to a server via a wireless mobile network.

In another embodiment, a data processor is configured to communicate with sensors in a vehicle to obtain operation data for the vehicle. A wireless interface is configured to wireless transmit the operation data. A mobile device is configured to receive the operation data from the wireless interface, produce instance performance data relating the operation data to time-of-day information and location data for the vehicle, and wirelessly transmit the instance performance data into a wireless mobile network. A server is configured to receive the instance performance data from the mobile device via the wireless mobile network. In an embodiment, the data processor and the wireless interface are fixed in the vehicle, and the mobile device comprises a cellular telephone. In an embodiment, the wireless interface is configured to wirelessly transmit locally within the vehicle.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an embodiment of a fleet management system in accordance with one or more aspects of the invention;

FIG. 2 is a block diagram depicting another embodiment of a fleet management system in accordance with one or more aspects of the invention;

FIG. 3 is a flow diagram depicting an exemplary embodiment of a method of vehicle performance tracking in accordance with one or more aspects of the invention; and

FIG. 4 is a flow diagram depicting another exemplary embodiment of a method of vehicle performance tracking in accordance with one or more aspects of the invention.

### DETAILED DESCRIPTION

Method and apparatus for tracking the performance of a vehicle, for example, a vehicle operating remotely (e.g., “on the road”) is described. An embodiment of the invention includes capturing the vehicle's operation data, transmitting the operation data to a mobile device using a wireless interface, storing the operation data with time information and location data for the vehicle as instance performance data, and transmitting the instance performance data to a server using a wireless mobile network.

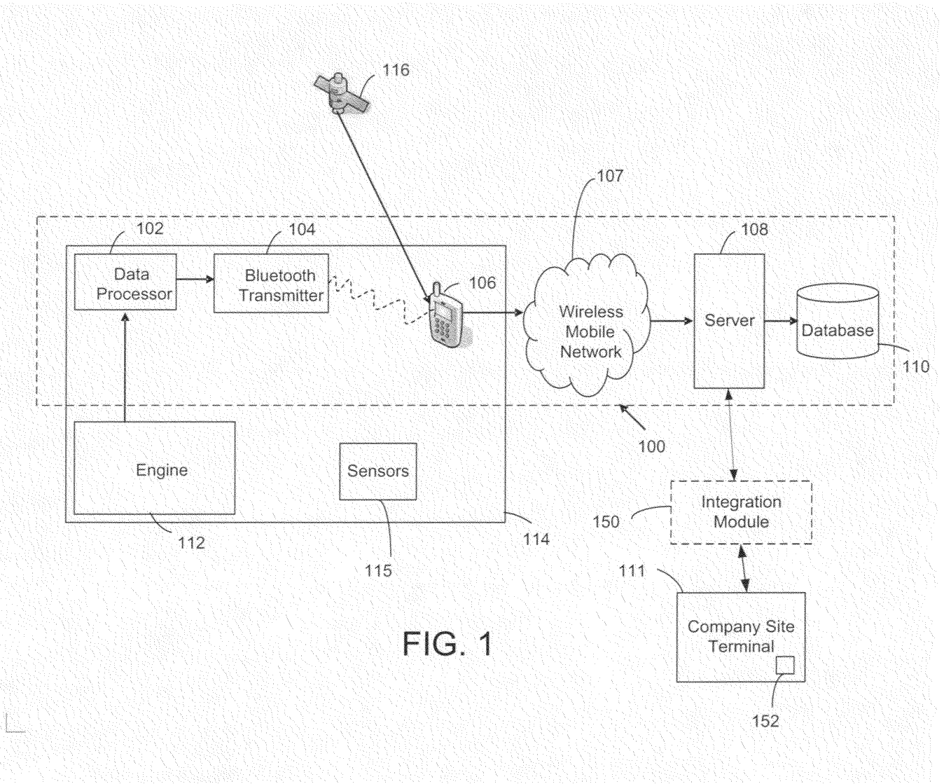

FIG. 1 is block diagram depicting a vehicle management system 100 for providing operation data in real time, in accordance with an embodiment of the present invention. The operation data may include, but are not limited to, parameters for fuel consumption, speed, engine state, throttle position, road speed, power takeoff status, percent accelerator pedal position, fuel level, average fuel rate, instantaneous fuel rate, instantaneous fuel economy, average fuel economy, engine speed, total idle hours, total idle fuel used, total vehicle distance traveled, and like type vehicle parameters known in the art or any combination thereof. In an embodiment, the vehicle management system 100 comprises a data processor 102, a wireless interface 104, a mobile device 106, a server 108, and a database 110 connected to the server 108. The data processor 102, the wireless interface 104, and the mobile device 106 are located within or proximate to a vehicle 114. In an embodiment, the data processor 102 and the wireless interface 104 are fixed within the vehicle 114. The mobile device 106 is movable within and without the vehicle 114.

The data processor 102 is interfaced to sensors 115 installed in the vehicle 114. At least some of the sensors 115 are installed in or otherwise monitor an engine 112 in the vehicle 114. The sensors 115 generate, measure or detect events associated with the operational parameters listed above. The events define the operation data of the vehicle 114. The wireless interface 104 is configured to wirelessly transmit the operation data. In an embodiment, the wireless interface 104 wirelessly transmits the operation data locally within or substantially within the vehicle 114. That is, the wireless interface 104 is configured to transmit signals to neighboring devices over short distances using a suitable radio transmission technology. For example, wireless interface 104 may comprise a BLUETOOTH interface. Those skilled in the art will appreciate that other types of wireless interfaces may be used that transmit over longer distances, such as IEEE 802.11a/b/g, and the like.

The mobile device 106 is configured to receive the operation data from the wireless interface 104. In another embodiment, the wireless interface 104 may be replaced by a wired interface and the mobile device 106 is configured to receive the operation data over this wired interface. Any well know wired interface may be used. The mobile device 106 is configured to form instance performance data that relates the operation data, time-of-day information, and location information. The mobile device 106 is also configured for communication with a wireless mobile network 107. In one embodiment of the invention, the wireless mobile network 107 is a conventional cellular network. Those skilled in the art will appreciate that various wireless mobile networks may be employed in various embodiments of the present invention including, without limitation, a Global System for Mobile communication (GSM) network, a Code Division Multiple Access (CDMA) network, and the like. In an embodiment, the mobile device 106 is configured to compute its position in a well known manner using a satellite positioning system (SPS) 116, such as the global positioning system (GPS) or the like. Alternatively, the mobile device 106 may compute its position via the wireless mobile network 107 using one or more well known techniques.

In an exemplary system, the mobile device 106 is coupled to the server 108 through the wireless mobile network 107. The mobile device 106 transmits the instance performance data to the server 108 using the wireless mobile network 107. The server 108 is a data processing device. Those skilled in the art will appreciate that various forms of data processing devices may be employed in various embodiments of the present invention including, without limitation, personal computers, servers, mainframes, and the like. The server 108 stores the instance performance data in the database 110. The database 110 is a logical unit of storage. In an embodiment, the database 110 may be formed from a portion of the overall storage of a physical device, by the storage of an entire physical device or by the storage of multiple physical devices combined together. The database 110 may also form part of the memory in the server 110.

In an embodiment, the data processor 102 captures the vehicle operation data from the sensors 115 while the vehicle 114 is operating remotely (i.e., on the road). The wireless interface 104 transmits the vehicle operation data to the mobile device 106, which may be held by the driver. In an embodiment of the invention, the mobile device 106 relates the vehicle operation data to time-of-day information and location information to define instance performance data. The driver may annotate the instance performance data via interaction with an input interface of the mobile device 106 (e.g., text information via keypad, voice information via speaker, and the like). For example, the driver may want to add a comment regarding condition of the engine 112 of the vehicle 114. The instance performance data is stored in the memory of the mobile device 106. The mobile device 106 may transmit the instance performance data after receiving input from the driver or automatically in accordance with a schedule or in accordance with any type of triggering event. In one embodiment of the present invention, the mobile device 106 may further transmit the instance performance data to the server 108, upon request from the server 108.

In one embodiment of the present invention, the instance performance data stored in the database 110 is transferred to update a company site terminal 111 operated by a customer. The company site terminal 111 and the server 108 may be at the same location or at geographically distinct locations. Examples of transfers of such data include, but are not limited to, transfers (uploads, downloads, e-mail, etc.) over the Internet and/or other computer networks via one or more data transfer protocols (e.g., HTTP, FTP, SMTP, etc.). In another embodiment, an integration module 150 is provided. The integration module 150 may be part of the server 108 or the company site terminal 111. The integration module extracts the instance performance data from the database 110 and integrates the data with an existing transportation management system (TMS) 152 of the customer. In another embodiment, the server 108 may provide one or more aspects of the instance performance data to engine manufacturers.

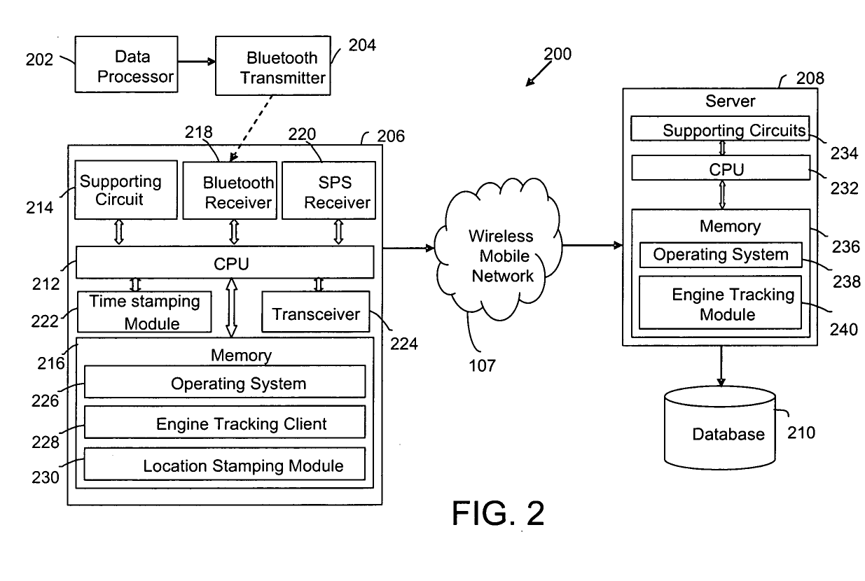

FIG. 2 is a block diagram depicting a vehicle management system 200 for tracking performance of a vehicle running at various geographic locations in real time, in accordance with an embodiment of the present invention. Elements of FIG. 2 that are the same or similar to those of FIG. 1 are designated with identical reference numerals. In the present embodiment, the mobile device 106 is a mobile computing device comprising at least one central processing unit (CPU) 212, a wireless transceiver 218, an SPS receiver 220, a cellular transceiver 224, a time stamping module 222, a memory 216, and supporting circuits 214. The supporting circuits 214 are well-known circuits that support the operation of the CPU 212 and the mobile device 106 including but not limited to, power supplies, cache, input/output circuits, batteries, network cards and the like.

The memory 216 may include, but not limited to, dynamic or static random access memory, magnetic or optical data storage disks, or magnetic data storage tapes, and the like. Other processing and memory means, including various computer readable media, may be used for storing and executing program instructions. The memory 212 includes an engine-tracking client 228 and a location-stamping module 230. The memory 212 may also include an operating system (OS) 226. The OS 226 may comprise various executable application modules.

As described above, the wireless interface 104 wirelessly transmits operation data for the vehicle to the mobile device 106. The mobile device 106 receives the operation data using the wireless transceiver 218. For example, the wireless transceiver 218 may be a BLUETOOTH transceiver or the like. The engine-tracking client 228 obtains the operation data and relates the operation data to time-of-day information and location information to define instance performance data. The engine-tracking client 228 obtains time-of-day information from the time stamping module 222, and location information from the location stamping module 230. The time-of-day data may be used to generate time stamps for the operation data. In an embodiment, the operation data comprises a plurality of events. The instance performance data may then comprise a time-ordered sequence of the events (e.g., each event may receive a time stamp with respect to time-of-day the event was generated, measured, or received). The location-stamping module 230 uses location information from the SPS receiver 220 to provide location stamps for the operation data. In an embodiment, each event in the instance performance data includes a location stamp based on where the event was generated, measured, or received. Operation of the SPS receiver 220 is well known in the art.

In an embodiment, the engine-tracking client 228 is configured with designated values (e.g., thresholds) for the events in the vehicle operation data. The engine-tracking client 228 may then compare the events received in the vehicle operation data with the designated values assigned to such events. The engine-tracking client 228 may update the instance performance data with the results of the comparison (e.g., identifying which events exceed a designated threshold). In an embodiment, the results of the comparison may be used to trigger the sending of the instance performance data to the server 108.

The engine-tracking client 228 may be configured with information related to the driver, including, without limitation, the driver's license number, details of the job assigned to the driver, and the like (“predefined driver-related information”). The engine-tracking client 228 may further be configured with information related to the vehicle 114 including, without limitation, a vehicle number, engine make details, and the like (“predefined vehicle related-information”). The engine-tracking client 228 may update the instance performance data with the predefined driver-related information and/or the predefined vehicle related information. In an embodiment, the engine-tracking client 228 is also configured to obtain real-time information related to the driver and/or the vehicle and annotate the instance performance data with the real-time information.

The engine-tracking client 228 may transmit the instance performance data to the server 208 using the cellular transceiver 224. The cellular transceiver 224 is a well known communicating device capable of both transmitting and receiving signals over the wireless mobile network 107. Those skilled in the art will appreciate that various transceivers that operate on different frequency bands may be used to implement the cellular transceiver 224, for example CDMA and GSM transceivers.

The server 108 is a computing device comprising at least one central processing unit (CPU) 232, support circuits 234, and memory 236. The CPU 232 comprises at least one microprocessor and/or microcontroller. The support circuits 234 are well-known circuits that support the operation of the CPU 232 including, but not limited to, power supplies, clocks, cache, input/output circuits, network cards, and the like. The memory 236 may include dynamic or static random access memory, magnetic or optical data storage disks, or magnetic data storage tapes, and the like. Other processing and memory means, including various computer readable media, may be used for storing and executing program instructions. The memory 236 comprises an operating system (OS) 238 and an engine-tracking module 240. The OS 238 may comprise various executable application modules. The engine-tracking module 240 receives the instance performance data from the mobile device 106 and stores it to the database 110.

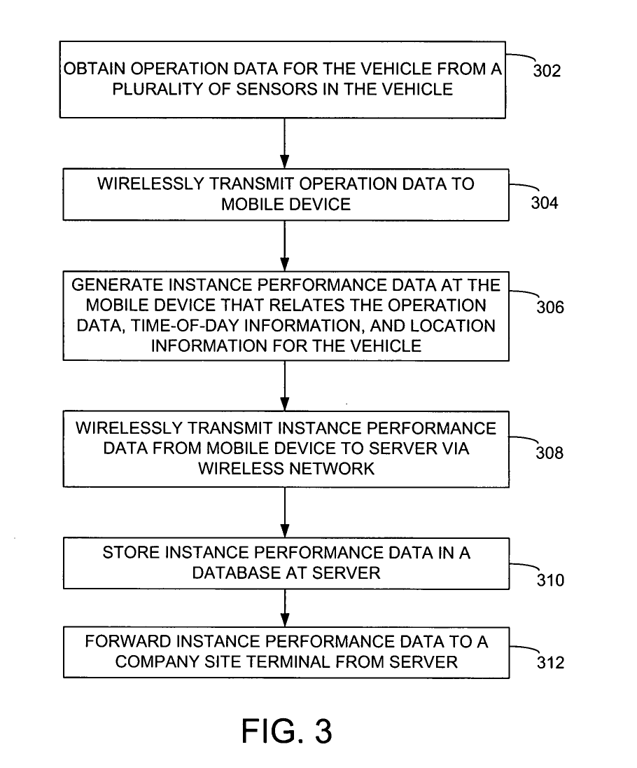

FIG. 3 is a flow diagram depicting an exemplary embodiment of a method 300 of vehicle performance tracking in accordance with one or more aspects of the invention. The method 300 begins at step 302, where operation data is obtained for the vehicle from a plurality of sensors in the vehicle. In an embodiment, the operation data is obtained from the sensors using a data processor in the vehicle. At step 304, the operation data is wirelessly transmitted to a mobile device. At step 306, the mobile device generates instance performance data that relates the operation data, time-of-day information, and location information for the vehicle. At step 308, the instance performance data is wirelessly transmitted from the mobile device to a server via a wireless mobile network. The instance performance data may be transmitted on command, upon request from the server, periodically in accordance with a schedule, or in response to a triggering event. At step 310, the instance performance data may be stored in a database from the server. At step 312, the instance performance data may be forwarded from the server to a company site terminal.

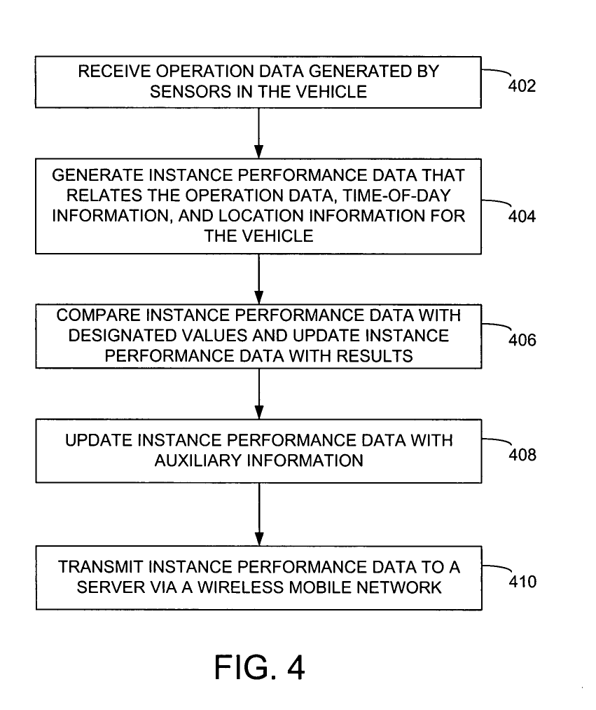

FIG. 4. is a flow diagram depicting an exemplary embodiment of a method 400 for vehicle performance tracking in accordance with one or more aspects of the invention. The method 400 begins at step 402, where operation data generated by sensors in the vehicle is received. At step 404, instance performance data is generated that relates the operation data, time-of-day information, and location information for the vehicle. At step 406, the instance performance data may be compared with designated values and the instance performance data may be updated with the results of the comparison. At step 408, the instance performance data may be updated with auxiliary information. The auxiliary information may comprise pre-defined driver-related information, pre-defined vehicle-related information, real-time driver related or vehicle related information, or a combination of such data. At step 410, the instance performance data is transmitted to a server via a wireless mobile network.

In the foregoing specification, specific embodiments of the present invention have been described. However, one of ordinary skill in the art will appreciate that various modifications and changes can be made without departing from the spirit and scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. Apparatus for vehicle performance tracking, comprising:
a wireless interface configured to receive operation data generated by a plurality of sensors in a vehicle;
a time stamping module for tracking time-of-day;
a location module for locating the vehicle;
an engine tracking client for producing instance performance data that relates the operation data, time-of-day information from the time stamping module, and location information from the location module; and
a cellular transceiver for transmitting the instance performance data to a server via a wireless mobile network.

2. The apparatus of claim 1, wherein the operation data comprises a plurality of events, and wherein the instance performance data comprises a time-ordered sequence of the plurality of events.

3. The apparatus of claim 2, wherein the engine tracking client is configured to store designated values for the plurality of events, compare the plurality of events with the designated values, and update the instance performance data with results of the comparison.

4. The apparatus of claim 1, wherein the engine tracking client is configured to update the instance performance data with at least one of predefined driver-related information or predefined vehicle-related information.

5. The apparatus of claim 1, wherein the engine tracking client is configured to obtain real-time information comprising at least one of driver-related information or vehicle related information and to annotate the instance performance data with the real-time information.

6. The apparatus of claim 1; wherein the location module comprises a satellite positioning system (SPS) receiver.

7. A method of vehicle performance tracking, comprising:
receiving operation data generated by a plurality of sensors in a vehicle;
generating instance performance data that relates the operation data, time-of-day information, and location information for the vehicle; and
transmitting the instance performance data to a server via a wireless mobile network.

8. The method of claim 7, wherein the operation data comprises a plurality of events, and wherein the instance performance data comprises a time-ordered sequence of the plurality of events.

9. The method of claim 8, further comprising:
storing designated values for the plurality of events;
comparing the plurality of events with the designated values; and
updating the instance performance data with results of the comparison.

10. The method of claim 7, further comprising:
updating the instance performance data with at least one of predefined driver-related information or predefined vehicle-related information.

11. The method of claim 7, further comprising:
obtaining real-time information comprising at least one of driver-related information or vehicle related information; and
annotating the instance performance data with the real-time information.

12. A system for vehicle performance tracking, comprising:
a data processor configured to communicate with sensors in a vehicle to obtain operation data for the vehicle;
a wireless interface configured to wirelessly transmit the operation data;
a mobile device configured to receive the operation data from the wireless interface, produce instance performance data relating the operation data to time-of-day information and location data for the vehicle, and wirelessly transmit the instance performance data into a wireless mobile network;
a server configured to receive the instance performance data from the mobile device via the wireless mobile network.

13. The system of claim 12, wherein the data processor and the wireless interface are fixed to the vehicle and the mobile device comprises a cellular telephone.

14. The system of claim 12, wherein the wireless interface wirelessly transmits the operation data locally within the vehicle.

15. The system of claim 12, wherein the mobile device comprises:
a satellite positioning system (SPS) receiver for locating the mobile device; and
a time capture module for tracking time-of-day.

16. The system of claim 12, further comprising:
a database in communication with the server for storing the instance performance data.

17. A method for vehicle performance tracking, comprising:
obtaining operation data for the vehicle from a plurality of sensors in the vehicle;
wirelessly transmitting the operation data;
receiving the operation data at a mobile device;
producing, at the mobile device, instance performance data that relates the operation data, time-of-day information, and location information for the vehicle;
wirelessly transmitting the instance performance data from the mobile device to a server via a wireless mobile network.

18. The method of claim 17, further comprising:
storing the instance performance data in a database.

19. The method of claim 17, further comprising:
forwarding instance performance data from the server to a company site terminal.

20. The method of claim 17, wherein the operation data comprises a plurality of events, and wherein the instance performance data comprises a time-ordered sequence of the plurality of events.
